(19) United States
(12) Patent Application Publication
(10) Pub. No.: US 2025/0171687 A1
(43) Pub. Date: May 29, 2025

(54) METHOD FOR PRODUCING QUANTUM DOT

(71) Applicant: NIPPON CHEMICAL INDUSTRIAL CO., LTD., Tokyo (JP)

(72) Inventors: Tomo Sakanoue, Tokyo (JP); Kazuhiro Nakatsui, Tokyo (JP); Masashi Sugiya, Tokyo (JP)

(73) Assignee: NIPPON CHEMICAL INDUSTRIAL CO., LTD., Tokyo (JP)

(21) Appl. No.: 18/842,482

(22) PCT Filed: Mar. 17, 2023
(86) PCT No.: PCT/JP2023/010652

§ 371 Date: Aug. 29, 2024

(30) Foreign Application Priority Data
Mar. 25, 2022 (JP) 2022-050547

(51) Int. Cl. C09K 11/88; B82Y 20/00; B82Y 40/00; C01B 25/08; C09K 11/02; C09K 11/08

(52) U.S. Cl. CPC C09K 11/883; C01B 25/087; C09K 11/025; C09K 11/0883; B82Y 20/00; B82Y 40/00

(57) ABSTRACT

Provided is a method for producing a quantum dot excellent in light stability by an industrially advantageous method. Provided is a method for producing a quantum dot, including: a washing step of washing a quantum dot by using an organic solvent capable of dissolving an impurity contained in a dispersion containing the quantum dot; and a surface-protecting step of adding a ligand being a specific phosphine compound to a dispersion of a washed quantum dot to protect a surface of the quantum dot with the ligand. The organic solvent in the washing step is preferably at least one selected from the group consisting of methanol, ethanol, acetone, 2-propanol, and acetonitrile.

### TECHNICAL FIELD

The present invention relates to a method for producing a quantum dot.

### BACKGROUND ART

In recent years, development of quantum dots as light emitting material has progressed. As typical quantum dots, cadmium-based quantum dots such as CdSe, CdTe, and CdS have been developed from the viewpoint of excellent emission characteristics, etc. Due to high toxicity and environmental load of cadmium, a cadmium-free quantum dot such as InP, CuInS₂, and ZnTeSe is expected to be developed.

As characteristics for the purpose of improving quality of the quantum dot, emission characteristics such as quantum yield and full width at half maximum (hereinafter also referred to as FWHM) of an emission peak are important; however, in addition to the emission characteristics, there are characteristics relating to stability such as storage stability, temperature stability, and light stability, which are also important factors for productization of the quantum dot together with the emission characteristics.

A cause of quality deterioration of the quantum dot is considered to be an effect brought about by defects present on the quantum dot surface. The emission characteristics and the stability can be improved by protecting these defects, and an aspect of this protection is a method of modifying the quantum dot surface with a ligand. For example, Patent Literature 1 mentions a sulfate salt, a sulfonate, a sulfinate, a phosphate salt, a phosphite, a phosphine, etc. as a polar head group, namely the ligand, to interact with the surface of a semiconductor nanocrystal (quantum dot) and a metal precursor, and describes that these form a coordinate bond with the surface of the semiconductor nanocrystal to attempt to protect the surface. Patent Literature 2 discloses use of a coordinative solvent for stabilizing a growing quantum dot, and exemplifies ligands such as an alkylphosphine, an alkylphosphine oxide, an alkylphosphonic acid, and alkylphosphinic acid, as the coordinative solvent. Patent Literature 3 describes that the quantum dot deteriorates because release of a ligand composed of a sulfur-based compound, phosphorus-based compound, etc. from the quantum dot surface due to light or heat facilitates adhesion of moisture and oxygen on the quantum dot. Patent Literature 3 discloses that, in order to prevent this deterioration, containing a phosphite-based compound in a light wavelength converting composition containing the quantum dot exhibits a function of substituting the ligand by the phosphite-based compound.

### CITATION LIST

### Patent Literature

Patent Literature 1
   International Publication No. WO2009/065010
Patent Literature 2
   International Publication No. WO2012/021643
Patent Literature 3
   Japanese Patent Laid-Open No. 2017-165860

### SUMMARY OF INVENTION

### Technical Problem

In the synthesis process of the quantum dot, a compound containing an element to be a raw material for the quantum dot, a reaction solvent, etc. are used in addition to the aforementioned ligand, and impurities such as an unreacted substance and a reaction byproduct are generated in the reaction system. These impurities deteriorate the quality of the quantum dot, and therefore need to be removed. In typical, an organic solvent that dissolves the impurities is added to the reaction system, and then the quantum dot and the solvent are separated, a so-called method of washing the quantum dot, is performed. However, even with the quantum dot via washing, deterioration of the emission intensity and persistence is observed in some cases, which needs to be improved for productization.

Therefore, an object of the present invention is to provide a method for producing a quantum dot excellent in light stability by an industrially advantageous method.

### Solution to Problem

As a result of extensive study for solving the above problem, the present inventors have found that the quantum dot via washing has a reduced amount of the ligand modifying the surface compared with the quantum dot before washing, which is caused by washing the quantum dot to release the ligand and generate defects on the quantum dot surface, and quality characteristics, specifically characteristics about the light stability, of the quantum dot deteriorate. In particular, the present inventors have found that the ligand coordinating to a Group 16 element such as S, Se, and Te is considerably released. The present invention has been thus completed.

In other words, the present invention is a method for producing a quantum dot, comprising:
a washing step of washing a quantum dot by using an organic solvent capable of dissolving an impurity contained in a dispersion containing the quantum dot; and
a surface-protecting step of adding a ligand represented by the following general formula (1) or the following general formula (2) to a dispersion of a washed quantum dot to protect a surface of the quantum dot with the ligand.

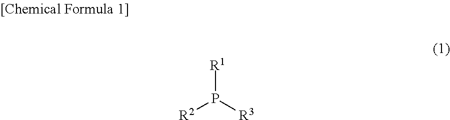

In the formula, R¹, R², and R³ represent a hydrogen atom, a hydroxy group, an alkyl group, a cycloalkyl group, an aryl group, a heteroaryl group, an aralkyl group, a heteroaralkyl group, an alkoxy group, or a thioalkoxy group. R¹, R², and R³ may be the same groups or different groups.

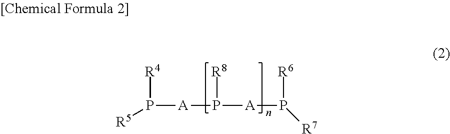

In the formula, R⁴, R⁵, R⁶, R⁷, and R⁸ represent a hydrogen atom, a hydroxy group, an alkyl group, a cycloalkyl group, an aryl group, a heteroaryl group, an aralkyl group, a heteroaralkyl group, an alkoxy group, or a thioalkoxy group. R⁴, R⁵, R⁶, R⁷, and R⁸ may be the same groups or different groups. When a plurality of Re are present, these may be the same groups or different groups, A represents an alkylene group, a cycloalkylene group, an arylene group, an alkoxylene group, or a thioalkoxylene group. “n” represents an integer of 0 to 3.

### Advantageous Effects of Invention

According to the present invention, provided is a method for producing a quantum dot excellent in the light stability by the industrially advantageous method.

### BRIEF DESCRIPTION OF DRAWINGS

FIG. 1 is a measurement result of a light stability test of a quantum dot dispersion obtained in Example 1.

FIG. 2 is a measurement result of a long-time light stability test of a quantum dot dispersion obtained in Example 1.

FIG. 3 is a measurement result of a light stability test of a quantum dot dispersion obtained in Example 2.

FIG. 4 is a measurement result of a light stability test of a quantum dot dispersion obtained in Example 3.

FIG. 5 is a measurement result of a light stability test of a quantum dot dispersion obtained in Example 4.

FIG. 6 is a measurement result of a light stability test of a quantum dot dispersion obtained in Example 5.

FIG. 7 is a measurement result of a light stability test of a quantum dot dispersion obtained in Comparative Example 1.

FIG. 8 is a measurement result of a light stability test of a quantum dot dispersion obtained in Comparative Example 2.

FIG. 9 is a measurement result of a light stability test of a quantum dot dispersion obtained in Comparative Example 3.

FIG. 10 is a measurement result of a light stability test of a quantum dot dispersion obtained in Comparative Example 4.

### DESCRIPTION OF EMBODIMENT

The present invention is a method for producing a quantum dot, comprising: a washing step of washing a quantum dot by using an organic solvent capable of dissolving an impurity contained in a dispersion containing the quantum dot; and a surface-protecting step of adding a ligand to a dispersion of a washed quantum dot to protect a surface of the quantum dot with the ligand. Hereinafter, a preferable embodiment of the method for producing a quantum dot of the present invention will be described.

The dispersion containing the quantum dots used in the present invention is a dispersion in which the quantum dots is dispersed in a solvent. An amount of the quantum dot dispersed in the solvent is preferably 0.1 mass or more and 50 mass % or less, and particularly preferably 1 mass % or more and 30 mass % or less from the viewpoint of storage stability of the dispersion and from the viewpoint of successful formability of a quantum dot dispersion resin or a quantum dot solid neat film. The quantum dot may be one obtained by reacting a raw material compound composed of elements to constitute the quantum dot in a solvent, or may be one in which a commercially available quantum dot is dispersed in a solvent. Hereinafter, a reaction process for reacting the raw material compound composed of elements to constitute the quantum dot in a solvent to obtain the dispersion containing the quantum dot will be described.

### <Reaction Process>

The reaction process in the present invention is a step of preparing the quantum dot dispersion in which the quantum dots are dispersed in a liquid. Examples of the quantum dot include: a cadmium-based quantum dot such as CdSe, CdTe, and CdS; and a cadmium-free quantum dot such as InP, CuInS, and ZnTeSe. In the present invention, the quantum dot preferably has a core-shell structure in which a shell material is formed on a surface of a core material, and particularly preferably has a core-shell structure, with a core composed of an InP-based quantum dot obtained by a reaction of at least a phosphorus source and an indium source, and a shell composed of a coating compound other than an InP-based one. The dispersion is preferably a non-polar organic solvent. Hereinafter, an aspect according to the quantum dot with the core composed of the InP-based quantum dot and the shell composed of the coating compound other than the InP-based one will be described in detail.

### (Phosphorus Source)

As the phosphorus source used in the reaction process of the present invention, various materials may be used according to a chemical synthesis method to be adopted. Examples thereof include: a phosphine derivative such as a silylphosphine compound and an aminophosphine compound; and phosphine gas. A silylphosphine compound represented by the following general formula (a) is preferred from the viewpoints of easy obtainability of the quantum dot, availability, and control of the particle size distribution of the resulting quantum dot. The silylphosphine compound used as phosphorus source is a tertiary compound having a phosphorus atom to which three silyl groups are bonded.

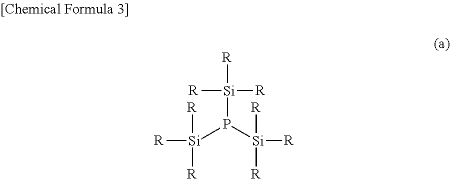

wherein R each independently represents an alkyl group having 1 or more and 5 or less carbon atoms or an aryl group having 6 or more and 10 or less carbon atoms.

Preferred examples of the alkyl group having 1 or more and 5 or less carbon atoms represented by R in the general formula (a) include a straight-chain or branched-chain alkyl group, and specifically, a methyl group, an ethyl group, an n-propyl group, and an iso-propyl group, an n-butyl group, a sec-butyl group, a tert-butyl group, an iso-butyl group, an n-amyl group, an iso-amyl group, and a tert-amyl group.

Examples of the aryl group represented by R having 6 or more and 10 or less carbon atoms in the general formula (a) include a phenyl group, a tolyl group, an ethylphenyl group, a propylphenyl group, an iso-propylphenyl group, a butylphenyl group, a sec-butylphenyl group, and a tert-butylphenyl group, an iso-butylphenyl group, a methylethylphenyl group and a trimethylphenyl group.

These alkyl groups and aryl groups may have one or two or more substituents. Examples of the substituent of alkyl groups include a hydroxy group, a halogen atom, a cyano group, and an amino group, and examples of the substituent of aryl groups include an alkyl group having 1 or more and 5 or less carbon atoms, an alkoxy group having 1 or more and 5 or less carbon atoms, a hydroxy group, a halogen atom, a cyano group, and an amino group. In the case where an aryl group is substituted with an alkyl group or an alkoxy group, the number of carbon atoms in the aryl group includes the number of carbon atoms of the alkyl group or the alkoxy group.

The plurality of R in the above general formula (a) may be the same or different. Further, the three silyl groups (—SiR₃) present in the above general formula (a) may be the same or different. As the silylphosphine compound represented by the above general formula (a), one with R being an alkyl group having 1 or more and 4 or less carbon atoms or a phenyl group unsubstituted or substituted with an alkyl group having 1 or more and 4 or less carbon atoms is preferred, from the viewpoint of a phosphorus source having excellent reactivity with other molecules such as an indium source during a synthesis reaction; and a trimethylsilyl group is particularly preferred.

### (Indium Source)

As the indium source used in producing the InP quantum dot, various sources may be used in accordance with a chemical synthesis method to be employed. Preferred examples thereof include indium organic carboxylate, from the viewpoint of easily obtaining a quantum dot, and from the viewpoints of easy availability and easy control of the particle size distribution of the resulting quantum dot, and for example, include an indium saturated aliphatic carboxylate such as indium acetate, indium formate, indium propionate, indium butyrate, indium valerate, indium caprylate, indium enanthate, indium caprylate, indium pelargonate, indium caprate, indium laurate, indium myristate, indium palmitate, indium margarate, indium stearate, indium oleate, indium 2-ethylhexanate; and an indium unsaturated carboxylate such as indium oleate and indium linoleate. In particular, from the viewpoints of availability and particle size distribution control, it is preferable to use at least one selected from the group consisting of indium acetate, indium laurate, indium myristate, indium palmitate, indium stearate, and indium oleate, and it is most preferable to use an indium salt of a higher carboxylic acid having 12 or more and 18 or less carbon atoms.

### (Reaction Between Phosphorus Source and Indium Source)

Examples of the chemical synthesis method of the InP quantum dot include a sol-gel method (colloid method), a hot soap method, an inverse micelle method, a solvothermal method, a molecular precursor method, a hydrothermal synthesis method, and a flux method. In the method for producing the InP quantum dot in the present invention, it is preferable that a phosphorus source and an indium source be mixed and reacted at a temperature of 20° C. or more and 150° C. or less to obtain an InP quantum dot precursor, followed by a reaction at a temperature of 200° C. or more and 350° C. or less to obtain an InP-based quantum dot.

### (Production Method of InP Quantum Dot Precursor)

An InP quantum dot precursor is a cluster including subdivisions of an InP quantum dot as nanoparticle having a particle size of several nm to several tens of nm obtained through a reaction between a phosphorus source and an indium source, including a specific number of constituent atoms, for example, several to several hundreds of atoms, with excellent stability in a solvent. The InP quantum dot precursor may be a magic size cluster composed of several tens to several hundreds of atoms, or may have a smaller number of atoms than that. Since the InP quantum dot precursor can have excellent stability in a solvent as described above, there is an advantage that a quantum dot having a narrow particle size distribution is easily obtained therefrom. In the present specification, InP in the InP quantum dot precursor means including In and P, though the molar ratio between In and P may not be 1:1. An InP quantum dot precursor usually includes In and P, and a ligand derived from a phosphorus source or an indium source as a raw material may be bonded to an In or P atom located in the outermost shell thereof. Examples of the ligand include an organic carboxylic acid residue in the case where the indium source is an indium salt of the organic carboxylic acid, and an alkylphosphine used as an additive.

The molar ratio between the phosphorus source and the indium source to be mixed during the reaction, i.e., P:In, is preferably 1:0.5 or more and 10 or less, more preferably 1:1 or more and 5 or less, from the viewpoint of successfully obtaining an InP quantum dot precursor.

It is preferable that the reaction between the phosphorus source and the indium source be performed in an organic solvent from the viewpoints of reactivity and stability. Examples of the organic solvent include a non-polar solvent from the viewpoint of stability of the phosphorus source and the indium source, and preferred examples thereof include solvents such as an aliphatic hydrocarbon, an unsaturated aliphatic hydrocarbon, an aromatic hydrocarbons, trialkylphosphine, and trialkylphosphine oxide from the viewpoints of reactivity and stability. Examples of the aliphatic hydrocarbon include n-hexane, n-heptane, n-octane, n-nonane, n-decane, n-dodecane, n-hexadecane, and n-octadecane. Examples of the unsaturated aliphatic hydrocarbon include 1-undecene, 1-dodecene, 1-tetradecene, 1-hexadecene, and 1-octadecene. Examples of the aromatic hydrocarbon include benzene, toluene, xylene, and styrene. Examples of the trialkylphosphine include triethylphosphine, tributylphosphine, tridecylphosphine, trihexylphosphine, trioctylphosphine, and tridodecylphosphine. Examples of the trialkylphosphine oxide include triethylphosphine oxide, tributylphosphine oxide, tridecylphosphine oxide, trihexylphosphine oxide, trioctylphosphine oxide, and tridodecylphosphine oxide.

It is preferable that the solvent be dehydrated before use from the viewpoint of preventing decomposition of the phosphorus source and the indium source and the resulting formation of impurities. The water content in the solvent is preferably 20 ppm or less based on mass. It is also preferable to degas the solvent before use to remove oxygen. Degassing may be done by any method such as reducing pressure and substitution with an inert atmosphere in a reaction vessel.

The concentrations of the phosphorus source and the indium source in the reaction solution obtained by mixing the phosphorus source and the indium source, as the phosphorus atom based concentration and the indium atom based concentration, respectively, relative to 100 g of the reaction solution are, for example, preferably in the range of 0.1 mmol or more and 10 mmol or less, more preferably in the range of 0.1 mmol or more and 3 mmol or less, from the viewpoints of reactivity and stability.

A preferred method of mixing a phosphorus source and an indium source includes dissolving the phosphorus source and the indium source in organic solvents, respectively, and mixing the solution in which the phosphorus source is dissolved and the solution in which the indium source is dissolved, from the viewpoint of easy generation of an InP quantum dot precursor. The solvent for dissolving the phosphorus source and the solvent for dissolving the indium source may be the same or different.

In this case, the phosphorus atom based concentration of the phosphorus source in the solution in which the phosphorus source is dissolved in an organic solvent is preferably in the range of 20 mmol/L or more and 2000 mmol/L or less, more preferably in the range of 80 mmol/L or more and 750 mmol or less, from the viewpoint of reactivity and stability. Also, the indium atom based concentration of the indium source in the solution in which the indium source is dissolved in an organic solvent is preferably in the range of 0.1 mmol/L or more and 20 mmol/L or less, more preferably 0.2 mmol/L or more and 10 mmol/L or less, from the viewpoint of reactivity and stability.

It is preferable to add an additive that can serve as a ligand to the reaction solution containing the phosphorus source and the indium source, from the viewpoint of improving the quality of the resulting InP quantum dot precursor and InP-based quantum dot. The present inventors believe that the coordination of an additive that can serve as a ligand to In or the change in polarity of the reaction field affects the quality of an InP quantum dot precursor and an InP-based quantum dot. Examples of the additive include a phosphine derivative, an amine derivative, and a phosphonic acid.

As the phosphine derivative, a primary or higher and tertiary or lower alkyl phosphine is preferred, and preferred examples thereof include one having a straight chain alkyl group having 2 or more and 18 or less carbon atoms in the molecule. The alkyl groups in the molecule may be the same or different. Specific examples of the straight chain alkylphosphine having an alkyl group having 2 or more and 18 or less carbon atoms include monoethylphosphine, monobutylphosphine, monodecylphosphine, monohexylphosphine, monooctylphosphine, and monododecylphosphine, monohexadecylphosphine, diethylphosphine, dibutylphosphine, didecylphosphine, dihexylphosphine, dioctylphosphine, didodecylphosphine, dihexadecylphosphine, triethylphosphine, tributylphosphine, tridecylphosphine, trihexylphosphine, trioctylphosphine, tridodecylphosphine, and trihexadecylphosphine. Among them, from the viewpoint of improving the quality of the resulting InP quantum dot precursor and InP-based quantum dot, those having an alkyl group having 4 or more and 12 or less carbon atoms in the molecule are particularly preferred. A trialkylphosphine is preferred, and trioctylphosphine is most preferred.

It is preferable that the amine derivative be a primary or higher and tertiary or lower alkylamine, and preferred examples thereof include a straight-chain alkyl amine with an alkyl group having 2 or more and 18 or less carbon atoms in the molecule, and an aromatic alkyl amine having 6 or more and 12 or less carbon atoms. The alkyl groups in the molecule may be the same or different. Specific examples of the alkylamine having a straight chain alkyl group having 2 or more and 18 or less carbon atoms include monoethylamine, monobutylamine, monodecylamine, monohexylamine, monooctylamine, monododecylamine, monohexadecylamine, diethylamine, dibutylamine, didecylamine, dihexylamine, dioctylamine, didodecylamine, dihexadecylamine, triethylamine, tributylamine, tridecylamine, trihexylamine, trioctylamine, tridodecylamine, and trihexadecylamine. Specific examples of the aromatic alkylamines with an alkyl groups having 6 or more and 12 or less carbon atoms include aniline, diphenylamine, triphenylamine, monobenzylamine, dibenzylamine, tribenzylamine, naphthylamine, dinaphthylamine, and trinaphthylamine. It is also preferable that the phosphonic acid be a monoalkylphosphonic acid having a straight chain alkyl group having 2 or more and 18 or less carbon atoms in the molecule.

It is preferable that the amount of the additive that can serve as a ligand in the reaction solution containing a phosphorus source and an indium source be 0.2 mol or more relative to 1 mol of In, from the viewpoint of enhancing the effect for improving the quality of the InP quantum dot precursor and the InP-based quantum dot through addition of the additive that can serve as a ligand. It is preferable that the amount added of the additive that can serve as a ligand be 20 mol or less relative to 1 mol of In from the viewpoint of the effect for improving quality. From these viewpoints, it is more preferable that the amount added of the additive that can serve as a ligand be 0.5 mol or more and 15 mol or less relative to 1 mol of In.

The timing of addition of the additive that can serve as a ligand to the reaction solution may be as follows. The additive that can serve as a ligand is mixed with an indium source to form a mixed solution, and the mixed solution may be mixed with a phosphorus source. Alternatively, the additive that can serve as a ligand is mixed with a phosphorus source to form a mixed solution, and this mixed solution may be mixed with an indium source. Alternatively, the additive that can serve as a ligand may be mixed with a mixed solution of a phosphorus source and an indium source.

The solution in which a phosphorus source is dissolved in an organic solvent and the solution in which an indium source is dissolved in an organic solvent may be preliminarily heated to a preferred reaction temperature described later or to a lower or higher temperature than that before mixing, or may be heated to a preferred reaction temperature described later after mixing. The preliminary heating temperature is preferably within 110° C. of the reaction temperature and at 20° C. or more, and more preferably within +5° C. of the reaction temperature and at 30° C. or more, from the viewpoints of reactivity and stability.

From the viewpoints of reactivity and stability, the reaction temperature between a phosphorus source and an indium source is preferably 20° C. or more and 150° C. or less, more preferably 40° C. or more and 120° C. or less. From the viewpoints of reactivity and stability, the reaction time at the reaction temperature is preferably 0.5 minutes or more and 180 minutes or less, more preferably 1 minute or more and 80 minutes or less.

Through the above steps, a reaction solution containing an InP quantum dot precursor is obtained.

The formation of an InP quantum dot precursor in the reaction solution can be confirmed, for example, through measurement of the ultraviolet-visible light absorption spectrum (UV-VIS spectrum). In the case where an InP quantum dot precursor is formed in a reaction solution obtained by reacting an In source and a P source, a peak or a shoulder is observed in the range of 300 nm or more and 460 nm or less in a UV-VIS spectrum. A shoulder clearly has an inflection point, though not having a sharp tip shape as clearly as a peak. In the case where a shoulder is observed, it is preferable to have one or two or more inflection points in the range of 300 nm or more and 460 nm or less, particularly 310 nm or more and 420 nm or less. It is preferable that the UV-VIS spectrum be measured at 0° C. or more and 40° C. or less. A sample solution is prepared by diluting the reaction solution with a solvent such as hexane. Each of the amounts of In and P in the sample solution in measurement is preferably in the range of 0.01 mmol or more and 1 mmol or less, more preferably 0.02 mmol or more and 0.3 mmol or less in terms of phosphorus atoms and indium atoms, respectively, relative to 100 g of the sample solution. Examples of the solvent of the reaction solution include solvents that can be suitably used for the reaction of the indium source and the phosphorus source, which will be described later. As described later, the InP quantum dot precursor in the solvent heated to 200° C. or more and 350° C. or less grows into an InP quantum dot, and a peak is observed in the UV-VIS spectrum of the reaction solution usually in the range of 400 nm or more and 650 nm or less. In contrast, in the reaction solution before heating, no peak is observed in the range of 400 nm or more and 650 nm or less.

Further, it can be confirmed that an InP quantum dot precursor is produced in the reaction solution by, for example, color change of the reaction solution into yellowish green to yellow, instead of by the UV-VIS spectrum. The color may be visually confirmed. For example, a reaction solution containing an InP magic size cluster is usually yellow, and a reaction solution containing a precursor composed of In and P and having a smaller number of atoms than the magic size cluster is usually pale yellow.

### (Method for Producing InP-Based Quantum Dot)

The InP-based quantum dot refers to a semiconductor nanoparticle containing at least In and P, having a quantum confinement effect. The quantum confinement effect means that electrons in a substance having about the size of Bohr radius cannot move freely, and the electron energy in such a state is not arbitrary but can take only a specific value. The particle size of a quantum dot (semiconductor nanoparticle) is usually in the range of several nm to several tens of nm. However, among those corresponding to the description of quantum dots, those corresponding to quantum dot precursors are not included in the category of quantum dots in the present invention.

The reaction solution containing the InP quantum dot precursor is at a temperature of preferably 20° C. or more and 150° C. or less, more preferably 40° C. or more and 120° C. or less, after completion of the reaction, and may be used at the temperature maintained or cooled to room temperature.

The reaction solution containing the InP quantum dot precursor may be directly heated or mixed with a heated solvent to obtain an InP-based quantum dot. In the case of directly heating the reaction solution containing the InP quantum dot precursor, from the viewpoint of particle size control, the reaction solution is heated at a temperature of preferably 200° C. or more and 350° C. or less, more preferably 220° C. or more and 330° C. or less to obtain the InP-based quantum dot. The rate of temperature rise during heating is preferably 1° C./min or more and 50° C./min or less, more preferably 2° C./min or more and 40° C./min or less from the viewpoints of time efficiency and particle size control. Further, from the viewpoint of particle size control, the heating time at the temperature is preferably 0.5 minutes or more and 180 minutes or less, and more preferably 1 minute or more and 60 minutes or less.

In the case of mixing the reaction solution containing the InP quantum dot precursor with a heated solvent, or in the case of obtaining an InP-based quantum dot by a so-called hot injection method, the reaction solution containing the InP quantum dot precursor may be rapidly added to an organic solvent heated preferably at a temperature of 200° C. or more and 350° C. or less, more preferably at 220° C. or more and 330° C. or less, to obtain an InP-based quantum dot, from the viewpoint of particle size control. As the organic solvent, the same organic solvent as used in the reaction between the phosphorus Source and the indium source may be used. Mixing of the reaction solution containing the InP quantum dot precursor and the organic solvent is performed at a holding temperature of 200° C. or more and 350° C. or less, more preferably at 220° C. or more and 330° C. or less, for 10 minutes or less, preferably for 0.1 minutes or more and 8 minutes or less, from the viewpoint of particle size control.

The stability of the InP quantum dot precursor in a solvent is thermodynamic, and the InP quantum dot precursor has a property reactive to heating. For example, an InP quantum dot precursor in the solvent can grow into an InP quantum dot by heating to preferably 200° C. or more and 350° C. or less, more preferably 220° C. or more and 330° C. or less. This can be confirmed by observation of a peak shift toward the long wavelength side in measurement of UV-VIS spectrum of the reaction solution after heating. For example, in the case where an InP quantum dot precursor in a solvent is heated to preferably 200° C. or more and 350° C. or less, more preferably 220° C. or more and 330° C. or less, without addition of elements other than In and P constituting the quantum dot, a peak is observed in the range of 400 nm or more and 600 nm or less in the UV-VIS spectrum. InP in the InP quantum dot means including In and P, though the molar ratio between In and P may not be 1:1. In the UV-VIS spectrum in the range of 300 nm or more and 800 nm or less of a liquid containing an InP quantum dot obtained by heating the InP quantum dot precursor to preferably 200° C. or more and 350° C. or less, more preferably 220° C. or more and 330° C. or less, it is preferable that an absorption peak on a lowest energy side be observed in the range of 400 nm or more and 600 nm or less, depending on the InP quantum dot precursor to obtain intended color.

It can also be confirmed that an InP quantum dot is produced in a reaction solution by, for example, color change of the reaction solution into yellow to red. The color may be visually confirmed.

The UV-VIS spectrum of the reaction solution and the color of the reaction solution after heating of an InP quantum dot precursor described above typically refer to the cases where heating is performed without addition of elements other than In and P constituting the quantum dot. However, as described above, the present invention does not exclude the case where heating is performed with addition of such a compound to an InP quantum dot precursor.

In the present invention, a quantum dot containing In and P but containing no other constituent elements, and a quantum dot containing In and P and a further constituent element are collectively referred to as “InP-based quantum dot”.

The InP-based quantum dot produced by the production method of the present invention may be a quantum dot composed of a composite compound having an element M other than phosphorus and indium in addition to In and P (also referred to as a composite quantum dot of In, P and M). It is preferable that the element M be at least one selected from the group of Be, Mg, Ca, Mn, Cu, Zn, Cd, B, Al, Ga, N, As, Sb, and Bi from the viewpoint of improving the quantum yield. Typical examples of the InP-based quantum dot containing element M include InGaP, InZnP, InAlP, InGaAlP, InNP, InAsP, InPSb, and InPBi. In order to obtain an InP-based quantum dot containing element M, a liquid containing a compound containing element M may be added to the reaction solution when the liquid containing the InP quantum dot precursor is heated, or a liquid containing the InP quantum dot precursor may be added to the reaction solution when the liquid containing a compound containing element M is heated. The compound containing element M is a compound in the form of chloride, bromide or iodide of element M, or in the form of higher carboxylate having 12 or more and 18 or less carbon atoms, in the case where element M is Be, Mg, Ca, Mn, Cu, Zn, Cd, B, Al and Ga. In the case where the compound is in the form of higher carboxylate, the carboxylic acid may be the same as or different from the carboxylic acid of the indium carboxylate used in the reaction. In the case where element M is N, As, Sb, and Bi, a compound in a form with element M to which three silyl groups or amino groups are bonded may be suitably used.

The surface of the InP-based quantum dot of the present invention may be treated with a surface treatment agent for the purpose of increasing the quantum yield. The surface treatment of the surface of an InP-based quantum dot protects the defects in the surface of the InP-based quantum dot, so that the quantum yield can be improved. Through performing the shell formation described below consecutively to the surface treatment, the FWHM and symmetry of the emission spectrum of the resulting quantum dot can be also improved. Examples of the suitable surface treatment agent include a metal-containing compound such as a metal carboxylate, a metal carbamate, a metal halide, a metal thiocarboxylate, a metal acetylacetonate and hydrates thereof, a halogen-containing compound such as a halogenated alkanoyl compound, a halogenated quaternary ammonium compound, a halogenated quaternary phosphonium compound, a halogenated aryl compound and a halogenated tertiary hydrocarbon compound, and an organic acid such as a carboxylic acid, a carbamic acid, a thiocarboxylic acid, a phosphonic acid and a sulfonic acid. Among these, metal carboxylates, metal carbamates, and metal halides are preferred from the viewpoint of further improving the quantum yield.

The metal carboxylate may have a straight chain, branched chain or cyclic alkyl group having 1 or more and 24 or less carbon atoms, containing a saturated or unsaturated bond, which may be unsubstituted or substituted with a halogen atom, or may have a plurality of carboxylic acids in the molecule. Examples of the metal of the metal carboxylate include Li, Na, K, Rb, Cs, Be, Mg, Ca, Sr, Ba, Sc, Y, Ti, Zr, V, Nb, Cr, Mo, Mn, Fe, Co, Ni, Cu, Ag, Zn, Cd, Hg, B, Al, Ga, In, Tl, Ge, Sn, Pb, Sb, Bi, La, Ce and Sm. Among these, the metal of the metal carboxylate is preferably Zn, Cd, Al and Ga, and more preferably Zn, from the viewpoint of further protecting defects in the surface of an InP-based quantum dot. Examples of the metal carboxylates include zinc acetate, zinc trifluoroacetate, zinc myristate, zinc oleate, and zinc benzoate.

For the metal carbamate, among the metals described above, Zn, Cd, Al and Ga are preferred, and Zn is more preferred from the viewpoint of further protecting defects in the surface of an InP-based quantum dot. Examples of such a metal carbamate include zinc dimethyldithiocarbamate, zinc diethyldithiocarbamate, zinc dibutyldithiocarbamate and zinc N-ethyl-N-phenyldithiocarbamate.

As the metal halide, among the metals described above, Zn, Cd, Al and Ga are preferred, and Zn is more preferred from the viewpoint of further protecting defects in the surface of an InP-based quantum dot. Examples of such a metal halide include zinc fluoride, zinc chloride, zinc bromide and zinc iodide.

As the method for surface-treating an InP-based quantum dot, for example, a surface treatment agent may be added to the reaction solution containing the InP-based quantum dot described above. The temperature at which the surface treatment agent is added to the reaction solution containing the InP-based quantum dot is preferably 0° C. or more and 350° C. or less, more preferably 20° C. or more and 250° C. or less, from the viewpoints of controlling particle size and improving the quantum yield. The treatment time is preferably 1 minute or more and 600 minutes or less, and more preferably 5 minutes or more and 240 minutes or less. The amount of the surface treatment agent added depends on the type of the surface treatment agent, being preferably 0.001 g/L or more and 1000 g/L or less, more preferably 0.1 g/L or more and 500 g/L or less, relative to the reaction solution containing the InP-based quantum dot.

Examples of the method for adding the surface treatment agent include a method of directly adding the surface treatment agent to the reaction solution, and a method of adding the surface treatment agent dissolved or dispersed in a solvent to the reaction solution. In the method of adding the surface treatment agent dissolved or dispersed in a solvent to the reaction solution, examples of the solvent for use include acetonitrile, propionitrile, isovaleronitrile, benzonitrile, acetone, methyl ethyl ketone, methyl isobutyl ketone, acetyl acetone, acetophenone, dimethylsulfoxide, dimethylformamide, dimethylacetamide, methanol, ethanol, isopropanol, cyclohexanol, phenol, methyl acetate, ethyl acetate, isopropyl acetate, phenyl acetate, tetrahydrofuran, tetrahydropyran, diethyl ether, t-butyl methyl ether, cyclohexyl methyl ether, anisole, diphenyl ether, hexane, cyclohexane, benzene, toluene, 1-decene, 1-octadecene, triethylamine, oleylamine, tri-n-octylamine, tri-n-octylphosphine, and water.

### (Production of Quantum Dot Having Core-Shell Structure)

The quantum dot obtained by the production method of the present invention has a core-shell structure with a core being the InP-based quantum dot, which is covered with a coating compound. On the core surface, a second inorganic material having a wider bandgap than the core is grown (shell layer) to protect defects on the core surface, etc., so that nonradiative deactivation due to charge recombination is suppressed and the quantum yield and the stability can be improved. Examples of the suitable coating compound include ZnS, ZnSe, ZnSeS, ZnTe, ZnSeTe, ZnTeS, Zno, ZnOS, ZnSeO, ZnTeO, GaP, and GaN. In the present invention, the coating compound is preferably obtained by reaction with at least a zinc source.

In the case of producing a quantum dot having a core-shell structure with a core being an InP-based quantum dot, which is covered with a coating compound, it is preferable that surface treatment and shell formation of the InP-based quantum dot as core be performed continuously from the viewpoint of improving the FWHM and symmetry of the emission spectrum. As the surface treatment agent used in the surface treatment, the same one as the surface treatment agent for InP-based quantum dot described above may be used. In performing surface treatment and shell formation continuously, the InP-based quantum dot as core is simultaneously present with the surface treatment agent and the coating compound raw material in a reaction solution, so that after performing the surface treatment of the InP-based dot as core at a predetermined temperature, the reaction solution is subsequently heated to form a shell of the coating compound.

In the case of producing a quantum dot having a core-shell structure with a core being an InP-based quantum dot, which is coated with a coating compound, examples of the method of forming the coating include mixing a reaction solution containing a surface-treated InP-based quantum dot and a coating compound raw material, or mixing a reaction solution containing an InP-based quantum dot, a coating compound raw material and a surface treatment agent, and causing a reaction at a temperature of 200° C. or more and 350° C. or less. Alternatively, a part of the coating compound raw material (for example, a metal source such as Zn) is heated to the same temperature, and added to and mixed with a reaction solution containing the InP-based quantum dot before the addition of the other coating compound raw material. The mixture is then heated to 20° C. or more and 350° C. or less, further 200° C. or more and 340° C. or less, and the remaining coating compound raw material may be added thereto to cause a reaction. The timing of mixing the metal source such as Zn with the reaction solution containing the InP-based quantum dot is not limited to before the addition of the other coating compound raw material, and may be after the addition.

As metal source for Zn and the like, which is the coating compound raw material, a halide or organic carboxylate thereof is preferably used. Examples of the metal halide as zinc source include zinc fluoride, zinc chloride, zinc bromide, and zinc iodide. As the metal organic carboxylate, a long-chain fatty acid salt having 12 or more and 18 or less carbon atoms is particularly preferably used in terms of particle size control, particle size distribution control, and quantum yield improvement.

Preferred examples of the sulfur source include a straight or branched long-chain alkanethiol having 8 or more and 18 or less carbon atoms such as dodecanethiol, and a trialkylphosphine sulfide compound having 4 or more and 12 or less carbon atoms such as and trioctylphosphine sulfide. Preferred examples of the selenium source include a trialkylphosphine selenide compound having 4 or more and 12 or less carbon atoms such as trioctylphosphine selenide. Preferred examples of the tellurium source include a trialkylphosphine telluride compound having 4 or more and 12 or less carbon atoms such as trioctylphosphine telluride.

In the case of using a metal such as zinc as the coating compound, for example, the amount of the coating compound raw material used is preferably 0.5 mol or more and 100 mol or less, and more preferably 4 mol or more and 50 mol or less, relative to 1 mol of indium in a reaction solution containing the InP-based quantum dot. The preferred amount of the sulfur source or selenium Source used corresponds to the amount of metal described above.

In the case of the core-shell type quantum dot with the core composed of the InP-based quantum dot and the shell layer formed by coating this core with a coating compound, the surface of the core-shell type quantum dot may be treated with a surface treatment agent or the like for the purpose of increasing the quantum yield. Through the surface treatment of the surface of the core-shell type quantum dot, defects in the surface of the shell layer can be protected, so that the quantum yield can be improved. Examples of the suitable surface treatment agent include a metal-containing compound such as a metal carboxylate, a metal carbamate, a metal thiocarboxylate, a metal halide, a metal acetylacetonate and hydrates thereof, and a halogen-containing compound such as a halogenated alkanoyl compound, a halogenated quaternary ammonium compound, a halogenated quaternary phosphonium compound, a halogenated aryl compound, and a halogenated tertiary hydrocarbon compound. Among these, a metal carboxylate, a metal carbamate, or a metal halide is preferred from the viewpoint of further improving the quantum yield.

The metal carboxylate may have a straight chain, branched chain or cyclic alkyl group having 1 or more and 24 or less carbon atoms, containing a saturated or unsaturated bond, which may be unsubstituted or substituted with a halogen atom, or may have a plurality of carboxylic acids in the molecule. Examples of the metal of the metal carboxylate include Li, Na, K, Rb, Cs, Be, Mg, Ca, Sr, Ba, Sc, Y, Ti, Zr, V, Nb, Cr, Mo, Mn, Fe, Co, Ni, Cu, Ag, Zn, Cd, Hg, B, Al, Ga, In, Tl, Ge, Sn, Pb, Sb, Bi, La, Ce and Sm. Among these, the metal of the metal carboxylate is preferably Zn, Cd, Al and Ga, and more preferably Zn, from the viewpoint of further protecting defects in the surface of a core-shell type quantum dot. Examples of the metal carboxylates include zinc acetate, zinc trifluoroacetate, zinc myristate, zinc oleate, and zinc benzoate.

As the metal carbamate, among the metals described above, Zn, Cd, Al and Ga are preferred, and Zn is more preferred from the viewpoint of further protecting defects in the surface of a core-shell type quantum dot. Examples of such a metal carbamate include zinc dimethyldithiocarbamate, zinc diethyldithiocarbamate, zinc dibutyldithiocarbamate and zinc N-ethyl-N-phenyldithiocarbamate.

As the metal of the metal halide, among the metals described above, Zn, Cd, Al and Ga are preferred, and Zn is more preferred from the viewpoint of further protecting defects in the surface of the InP-based quantum dot. Examples of such a metal halide include zinc fluoride, zinc chloride, zinc bromide and zinc iodide.

As the method for surface-treating the shell layer, for example, a surface treatment agent may be added to the reaction solution containing the core-shell type quantum dot. The temperature at which the surface treatment agent is added to the reaction solution containing the core-shell type quantum dot is preferably 0° C. or more and 350° C. or less, more preferably 20° C. or more and 300° C. or less, from the viewpoints of controlling particle size and improving the quantum yield. The treatment time is preferably 1 minute or more and 600 minutes or less, and more preferably 5 minutes or more and 240 minutes or less. The amount of the surface treatment agent added depends on the type of the surface treatment agent, being preferably 0.01 g/L or more and 1000 g/L or less, more preferably 0.1 g/L or more and 100 g/L or less, relative to the reaction solution containing the core-shell type quantum dot.

Examples of the method for adding the surface treatment agent include a method of directly adding the surface treatment agent to the reaction solution, and a method of adding the surface treatment agent dissolved or dispersed in a solvent to the reaction solution. In the method of adding the surface treatment agent dissolved or dispersed in a solvent to the reaction solution, examples of the solvent for use include acetonitrile, propionitrile, isovaleronitrile, benzonitrile, acetone, methyl ethyl ketone, methyl isobutyl ketone, acetylacetone, acetophenone, dimethyl sulfoxide, dimethylformamide, dimethylacetamide, methanol, ethanol, isopropanol, cyclohexanol, phenol, methyl acetate, ethyl acetate, isopropyl acetate, phenyl acetate, tetrahydrofuran, tetrahydropyran, diethyl ether, t-butyl methyl ether, cyclohexyl methyl ether, anisole, diphenyl ether, hexane, cyclohexane, benzene, toluene, 1-decene, 1-octadecene, triethylamine, oleylamine, tri-n-octylamine, tri-n-octylphosphine, and water.

Through the above steps, the dispersion containing the quantum dot is obtained.

### <Washing Step>

The washing step in the present invention is a step of washing the quantum dot by using an organic solvent capable of dissolving an impurity contained in the dispersion containing the quantum dot obtained in the reaction step or in the dispersion containing a commercially available quantum dot. The dispersion contains impurities such as: an unreacted material of the raw material such as P and In, which constitute the quantum dot, and the element M added as desired; an excess additive such as the ligand added for protecting the defects on the quantum dot surface; a byproduct generated in the reaction in synthesis of the quantum dot; and the like. These impurities adversely affect the light stability of the quantum dot, and in addition, cause shortcomings such as precipitate generation, gas generation, increase in viscosity, unintended chemical reaction, inhibition of uniform formation of the quantum dot thin film when the quantum dot is used as a material to produce a device, and thereby the quantum dot obtained in the reaction step needs to be purified by mixing, with the dispersion, the organic solvent capable of dissolving and removing these impurities to separate the quantum dot.

The organic solvent used in the washing step of the present invention is not particularly limited as long as the solvent can dissolve the impurities and separate the quantum dot without decomposition. Examples thereof include: alcohol solvents such as methanol, ethanol, 2-propanol, butanol, pentanol, ethylene glycol, and propylene glycol; ketone solvents such as acetone, methyl ethyl ketone, diethyl ketone, and acetophenone; nitrogen-containing solvents such as acetonitrile, N-methylpyrrolidone, and dimethylformamide; ether solvents such as dimethyl ether, dipropyl ether, and tetrahydrofuran; halogen-element-containing solvents such as chloroform, methylene chloride, trichloroethylene, dichloroethane, and tetrachloroethane; and aromatic hydrocarbon solvents such as benzene, toluene, and xylene; or a mixed solvent thereof. Among these organic solvents, the alcohol solvents and the ketone solvents are preferred, and methanol, ethanol, acetone, 2-propanol, and acetonitrile are particularly preferred from the viewpoint of easy dissolution of the impurities and separation of the quantum dot.

Examples of the method of mixing the organic solvent and the dispersion in the washing step include a method of adding the organic solvent to the dispersion containing the quantum dots, a method of adding the dispersion containing the quantum dots to the organic solvent, and a method of simultaneously adding the dispersion containing the quantum dots and the organic solvent at equal amounts to a reaction vessel.

An amount of the organic solvent to be mixed is preferably 0.1 part by mass or more and 100 parts by mass, and particularly preferably 0.5 parts by mass or more and 10 parts by mass or less relative to 1 part by mass of the dispersion, depending on the type of the organic solvent to be used, the amount of the impurities contained in the dispersion, and the amount of the quantum dot.

The dispersion containing the quantum dots and the organic solvent are mixed, and then the washed quantum dots and the organic solvent containing the impurities are separated. A method of this separation is not particularly limited, and may be performed by a common method such as centrifugation, decantation, and suction filtration.

Through the above steps, the quantum dot washed to remove the impurities is obtained.

### <Surface-Protecting Step>

The surface-protecting step in the present invention is a step of protecting the surface of the washed quantum dot obtained in the washing step with a ligand. On the washed quantum dot, the ligand modifying the surface is released by the washing step, and thereby the defects are generated on the quantum dot surface. This released ligand is replenished to inhibit deterioration of the quality characteristic, specifically the characteristics about the light stability, of the quantum dot.

As the ligand used in the surface-protecting step of the present invention, a ligand composed of a phosphorus compound represented by the following general formula (1) is preferably used.

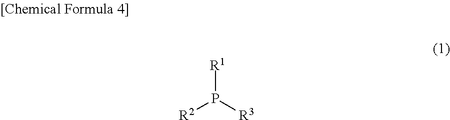

In the formula, R¹, R², and R³ represent a hydrogen atom, a hydroxy group, an alkyl group, a cycloalkyl group, an aryl group, a heteroaryl group, an aralkyl group, a heteroaralkyl group, an alkoxy group, or a thioalkoxy group, and R¹, R², and R³ may be the same groups or different groups.

The alkyl group is preferably a linear or branched alkyl group having 1 or more and 12 or less, particularly 1 or more and 10 or less, carbon atoms. Specific examples thereof include a methyl group, an ethyl group, a n-propyl group, an iso-propyl group, a n-butyl group, a 2-butyl group, an iso-butyl group, a tert-butyl group, a n-pentyl group, a 2-pentyl group, a tert-pentyl group, a 2-methylbutyl group, a 3-methylbutyl group, a 2,2-dimethylpropyl group, a n-hexyl group, a 2-hexyl group, a 3-hexyl group, a tert-hexyl group, a 2-methylpentyl group, a 3-methylpentyl group, a 4-methylpentyl group, a n-octyl group, a 2-octyl group, a 3-octyl group, a 4-octyl group, a tert-octyl group, a 2-methylheptyl group, a 3-methylheptyl group, a 4-methylheptyl group, a 2,2-dimethylhexyl group, a 2,3-dimethylhexyl group, a 2,4-dimethylhexyl group, a 2,5-dimethylhexyl group, a n-decyl group, a 2-decyl group, a 3-decyl group, a 4-decyl group, a 5-decyl group, a tert-decyl group, a 2-methylnonyl group, a 3-methylnonyl group, a 4-methylnonyl group, a 5-methylnonyl group, a 2,2-dimethyloctyl group, a 2,3-dimethyloctyl group, a 2,4-dimethyloctyl group, a 2,5-dimethyloctyl group, a 2,6-dimethyloctyl group, and a 2,7-dimethyloctyl group.

The cycloalkyl group is preferably a cycloalkyl group having 3 or more and 16 or less carbon atoms. Specific examples thereof include a cyclopropyl group, a cyclobutyl group, a cyclopentyl group, a cyclohexyl group, a cycloheptyl group, a cyclooctyl group, a cyclononyl group, and a cyclodecyl group. The cycloalkyl group includes a polycyclic alkyl group. Examples thereof include a menthyl group, a bornyl group, a norbornyl group, and an adamantyl group.

The aryl group is preferably a phenyl group having 6 or more and 16 or less carbon atoms. Specific examples thereof include a phenyl group, a 2-methylphenyl group, a 3-methylphenyl group, a 4-methylphenyl group, and a naphthyl group.

Examples of the heteroaryl group preferably include a five-membered or six-membered monocyclic aromatic heterocyclic group or polycyclic aromatic heterocyclic group. For example, the heteroaryl group is preferably an aromatic heterocyclic group having 1 or more and 3 or less heteroatoms such as a nitrogen atom, an oxygen atom, and/or a sulfur atom. Specific examples thereof include a pyridyl group, an imidazolyl group, a thiazolyl group, a furfuryl group, a pyranyl group, a furyl group, a benzofuryl group, and a thienyl group.

The aralkyl group is preferably an aralkyl group having 7 or more and 12 or less carbon atoms. Specific examples thereof include a benzyl group, a 2-phenylethyl group, a 1-phenylpropyl group, a 2-phenylpropyl group, a 3-phenylpropyl group, a 1-phenylbutyl group, a 2-phenylbutyl group, a 3-phenylbutyl group, a 4-phenylbutyl group, a 1-phenylpentyl group, a 2-phenylpentyl group, a 3-phenylpentyl group, a 4-phenylpentyl group, a 5-phenylpentyl group, a 1-phenylhexyl group, a 2-phenylhexyl group, a 3-phenylhexyl group, a 4-phenylhexyl group, a 5-phenylhexyl group, and a 6-phenylhexyl group.

The heteroaralkyl group is preferably a heteroaralkyl group having 6 or more and 16 or less carbon atoms. Specific examples thereof include a 2-pyridylmethyl group, a 4-pyridylmethyl group, an imidazolylmethyl group, and a thiazolylethyl group.

The alkoxy group is preferably a group in which the aforementioned alkyl group, cycloalkyl group, aryl group, heteroaryl group, aralkyl group, and heteroaralkyl group are bonded via oxygen. Examples thereof include a methoxy group, an ethoxy group, a propoxy group, a butoxy group, a pentyloxy group, a hexyloxy group, a heptyloxy group, an octyloxy group, a nonyloxy group, a decyloxy group, a dodecyloxy group, a phenyloxy group, and a benzyloxy group.

The thioalkoxy group is preferably a group in which the aforementioned alkyl group, cycloalkyl group, aryl group, heteroaryl group, aralkyl group, and heteroaralkyl group are bonded via sulfur. Examples thereof include a thiomethoxy group, a thioethoxy group, a thiopropoxy group, a thiobutoxy group, a thiopentyloxy group, a thiohexyloxy group, a thioheptyloxy group, a thiooctyloxy group, a thiononyloxy group, a thiodecyloxy group, a thiododecyloxy group, a thiophenyloxy group, and a thiobenzyloxy group.

The alkyl group, the cycloalkyl group, the aryl group, the heteroaryl group, the aralkyl group, the heteroaralkyl group, the alkoxy group, and the thioalkoxy group may further have a substituent. Examples of the substituent include an alkyl group, a cycloalkyl group, a halogen group, and an alkoxy group.

R¹, R², and R³ in the general formula (1) may be the same groups or different groups. In the present invention, R¹, R², and R³ are preferably the same groups from the viewpoint of easily obtaining the effect of the surface protection and convenient handling.

As the ligand used in the surface-protecting step of the present invention, a ligand composed of a phosphorus compound represented by the following general formula (2) is preferably used.

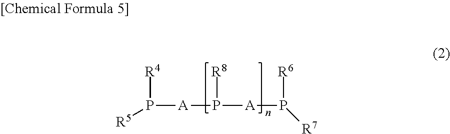

In the formula, R⁴, R⁵, R⁶, R⁷, and R⁸ represent a hydrogen atom, a hydroxy group, an alkyl group, a cycloalkyl group, an aryl group, a heteroaryl group, an aralkyl group, a heteroaralkyl group, an alkoxy group, or a thioalkoxy group. R⁴, R⁵, R⁶, R⁷, and R⁸ may be the same groups or different groups. When a plurality of Re are present, these may be the same groups or different groups. A represents an alkylene group, a cycloalkylene group, an arylene group, an alkoxylene group, or a thioalkoxylene group. “n” represents an integer of 0 to 3.

The alkyl group, the cycloalkyl group, the aryl group, the heteroaryl group, the aralkyl group, the heteroaralkyl group, the alkoxy group, and the thioalkoxy group are the same as the groups in the general formula (1).

The alkylene group is preferably a linear or branched alkylene group having 1 or more and 12 or less, particularly preferably 1 or more and 10 or less, carbon atoms. Specific examples thereof include a methylene group, an ethylene group, a n-propylene group, an iso-propylene group, a n-butylene group, a 2-butylene group, an iso-butylene group, a tert-butylene group, a n-pentylene group, a 2-pentylene group, a tert-pentylene group, a 2-methylbutylene group, a 3-methylbutylene group, a 2,2-dimethylpropylene group, a n-hexylene group, a 2-hexylene group, a 3-hexylene group, a tert-hexylene group, a 2-methylpentylene group, a 3-methylpentylene group, a 4-methylpentylene group, a n-octylene group, a 2-octylene group, a 3-octylene group, a 4-octylene group, a tert-octylene group, a 2-methylheptylene group, a 3-methylheptylene group, a 4-methylheptylene group, a 2,2-dimethylhexylene group, a 2,3-dimethylhexylene group, a 2,4-dimethylhexylene group, a 2,5-dimethylhexylene group, a n-decylene group, a 2-decylene group, a 3-decylene group, a 4-decylene group, a 5-decylene group, a tert-decylene group, a 2-methylnonylene group, a 3-methylnonylene group, a 4-methylnonylene group, a 5-methylnonylene group, a 2,2-dimethyloctylene group, a 2,3-dimethyloctylene group, a 2,4-dimethyloctylene group, a 2,5-dimethyloctylene group, a 2,6-dimethyloctylene group, and a 2,7-dimethyloctylene group.

The cycloalkylene group is preferably a cycloalkylene group having 3 or more and 16 or less carbon atoms. Specific examples thereof include a cyclopropylene group, a cyclobutylene group, a cyclopentylene group, a cyclohexylene group, a cycloheptylene group, a cyclooctylene group, a cyclononylene group, and a cyclodecylene group. The cycloalkylene group includes a polycyclic alkylene group. Examples thereof include a menthylene group, a bornylene group, a norbornylene group, and an adamantylene group.

The arylene group is preferably a phenylene group having 6 or more and 16 or less carbon atoms. Specific examples thereof include a phenylene group, a 2-methylphenylene group, a 3-methylphenylene group, a 4-methylphenylene group, and a naphthylene group.

The alkoxylene group is preferably a group in which the aforementioned alkylene group, cycloalkylene group, and arylene group are bonded via oxygen. Examples thereof include a methoxylene group, an ethoxylene group, a propoxylene group, a butoxylene group, a pentyloxylene group, a hexyloxylene group, a heptyloxylene group, an octyloxylene group, a nonyloxylene group, a decyloxylene group, a dodecyloxylene group, a phenyloxylene group, and a benzyloxylene group.

The thioalkoxylene group is preferably a group in which the aforementioned alkylene group, cycloalkylene group, and arylene group are bonded via sulfur. Examples thereof include a thiomethoxylene group, a thioethoxylene group, a thiopropoxylene group, a thiobutoxylene group, a thiopentyloxylene group, a thiohexyloxylene group, a thioheptyloxylene group, a thiooctyloxylene group, a thiononyloxylene group, a thiodecyloxylene group, a thiododecyloxylene group, a thiophenyloxylene group, and a thiobenzyloxylene group.

The alkylene group, the cycloalkylene group, the arylene group, the alkoxylene group, and the thioalkoxylene group may further have a substituent. Examples of the substituent include an alkyl group, a cycloalkyl group, a halogen group, and an alkoxy group.

Each of R¹ and R² in the general formula (1) may be the same groups or different groups. In the present invention, R¹ and R² are preferably the same groups from the viewpoint of easily obtaining the effect of the surface protection and convenient handling.

Among the ligand composed of the phosphorus compound represented by the general formula (1) or the general formula (2), the ligand used in the surface-protecting step of the present invention is preferably a ligand represented by the general formula (1) wherein R¹, R², and R³ are the same alkyl groups or alkoxy groups, or more preferably a ligand represented by the general formula (2) wherein R⁴, R⁵, R⁶, and R⁷ are the same alkyl groups or alkoxy groups, A is an alkylene group, and “n” is 0 from the viewpoint of an excellent effect of the surface protection and convenient handling.

Examples of the ligand represented by the general formula (1) wherein R¹, R², and R³ are the same alkyl groups include triethylphosphine, tributylphosphine, tridecylphosphine, trihexylphosphine, trioctylphosphine, and tridecylphosphine. Examples of the ligand represented by the general formula (1) wherein R¹, R², and R³ are the same alkoxy groups include triethylphosphite, tributylphosphite, tridecylphosphite, trihexylphosphite, trioctylphosphite, and tridecylphosphite.

Examples of the ligand represented by the general formula (2) wherein R⁴, R⁵, R⁶, and R⁷ are the same alkyl groups, A is an alkylene group, and “n” is 0 include trimethylenebis(diethylphosphine), trimethylenebis(dibutylphosphine), trimethylenebis(didecylphosphine), trimethylenebis(dihexylphosphine), trimethylenebis(dioctylphosphine), and trimethylenebis(didodecylphosphine).

Examples of the ligand represented by the general formula (2) wherein R⁴, R⁵, Re, and R′ are the same alkoxy groups, A is an alkylene group, and “n” is 0 include trimethylenebis(diethylphosphite), trimethylenebis(dibutylphosphite), trimethylenebis(didecylphosphite), trimethylenebis(dihexylphosphite), trimethylenebis(dioctylphosphite), and trimethylenebis(didodecylphosphite).

In the washing step, the impurities contained in the dispersion containing the quantum dots is washed to remove the unreacted material of the raw material compound, the excess additive such as the ligand, and the byproduct in the quantum dot synthesis, and the effect on the shortcomings in the device production etc. can be inhibited. However, the investigation by the present inventors has revealed that this washing considerably releases the ligand coordinating on the quantum dot surface, specifically the phosphorus-based ligand. Then, the present inventors have found that, in the phosphorus-based ligand, a ligand in which an element coordinating to the quantum dot surface is phosphorus itself is released to affect the light stability. This ligand in which the coordinating element is phosphorus itself is considered to coordinate with a chalcogen element such as S, Se, and Te. The present inventors consider that, in the surface-protecting step of the present invention, the phosphorus compound represented by the general formula (1) or the general formula (2) coordinates with the chalcogen element to protect the quantum dot surface, and thus oxidation of the quantum dot is inhibited to yield excellent light stability.

A method for protecting the surface of the quantum dot in the surface-protecting step can be performed by adding the ligand to the dispersion in which the quantum dots obtained in the washing step are dispersed in a solvent. A temperature at which the ligand is added to the dispersion containing the quantum dots is preferably 0° C. or more and 350° C. or less, and further preferably 20° C. or more and 300° C. or less from the viewpoint of successfully proceeding the surface protection of the quantum dot. The treatment time is preferably 1 minute or more and 600 minutes or less, and further preferably 5 minutes or more and 240 minutes or less. An amount of the ligand added is preferably 0.01 g/L or more and 1000 g/L or less, and more preferably 0.1 g/L or more and 100 g/L or less relative to the reaction solution containing the quantum dots, depending on a type of the ligand.

The solvent to disperse the washed quantum dot is preferably a solvent composed of an aliphatic hydrocarbon. Examples of the aliphatic hydrocarbon include: saturated hydrocarbons such as n-hexane, n-heptane, n-octane, n-nonane, n-decane, n-dodecane, n-hexadecane, and n-octadecane; and unsaturated aliphatic hydrocarbons such as 1-undecene, 1-dodecene, 1-tetradecene, 1-hexadecene, and 1-octadecene. The aliphatic hydrocarbon used as the solvent may be singly, or two or more thereof may be mixed for use.

Examples of the method of adding the ligand include a method of directly adding the ligand to the dispersion containing the quantum dots, and a method of adding the ligand in a solvent in a dissolved or dispersed state to the dispersion. As the solvent for the case where the ligand is added in a solvent in a dissolved or dispersed state to the reaction solution, acetonitrile, propionitrile, isovaleronitrile, benzonitrile, acetone, methyl ethyl ketone, methyl isobutyl ketone, acetylacetone, acetophenone, dimethyl sulfoxide, dimethylformamide, dimethylacetamide, methanol, ethanol, isopropanol, cyclohexanol, phenol, methyl acetate, ethyl acetate, isopropyl acetate, phenyl acetate, tetrahydrofuran, tetrahydropyran, diethyl ether, t-butyl methyl ether, cyclohexyl methyl ether, anisole, diphenyl ether, hexane, cyclohexane, benzene, toluene, 1-decene, 1-octadecene, triethylamine, oleylamine, tri-n-octylamine, tri-n-octylphosphine, water, etc. can be used.

The quantum dot obtained by the above method has high quality with excellent light stability, and being suitably used for a single electron transistor, a security ink, a quantum teleportation, a laser, a solar cell, a quantum computer, a biomarker, a light emitting diode, a display backlight, and a color filter.

### EXAMPLES

The present invention is described in more detail with reference to Examples below, though the present invention is not limited thereto. In Examples, properties were measured by the following method.

### (1) Maximum Fluorescence Wavelength

The obtained octane dispersion was measured with an absolute PL quantum yield measurement device (Quantaurus-QY, manufactured by Hamamatsu Photonics K.K.) under measurement conditions at an excitation wavelength of 450 nm and a measurement wavelength in a range of 200 nm to 1100 nm.

### (2) Light Stability Test

The quantum dot dispersion obtained in each of Examples and each of Comparative Examples was diluted with octane so that an absorbance at 450 nm was 0.3 to obtain a diluted liquid, and then 3.0 g of this diluted liquid was sealed in a 6-ml glass vial for use as a sample for a light stability test.

Then, parallel light having an energy density of 150 mW/cm² prepared with a lens from light emitted from a blue LED (ILH-ON01-DEBL-SC211-WIR200, manufactured by Intelligent LED Solutions) was continuously radiated from a bottom direction of this sample, and change in the fluorescence intensity at this time was detected with a photodiode (Si photodiode manufactured by Thorlabs, SM05PDIA) to evaluate the light stability.

### Example 1

### <Reaction Step>

To 1.578 g of 1-octadecene, 1.275 g of indium myristate was added, and the mixture was heated to 120° C. while stirring under reduced pressure and degassed for 1.5 hours. After degassing, the pressure was returned to atmospheric pressure with nitrogen gas, and the mixture was cooled to 60° C. to obtain a 1-octadecene solution of indium myristate. While keeping the resulting 1-octadecene solution of indium myristate at a temperature of 60° C. under nitrogen atmosphere, 2.505 g of trioctylphosphine containing 10 mass of tris(trimethylsilyl) phosphine was added thereto. The mixture was maintained for 20 minutes, and then naturally cooled to 20° C. As a result, a yellow liquid containing an InP quantum dot precursor was obtained.

Separately to this, 31.56 g of 1-octadecene was heated to 120° C. while stirring under a reduced pressure to be degassed for 1.5 hours. Then, the pressure was returned to atmospheric pressure with nitrogen gas, and the temperature was raised to 300° C., 5.4 g of the solution containing the InP quantum dot precursor was added, and the mixture was heated to 270° C. and held for 2 minutes. As a result, a brown solution containing the InP quantum dots was obtained.

Subsequently, 7.54 g of zinc oleate, 4.08 g zinc chloride, 4.48 g of trioctylphosphine selenide, 13.28 g of trioctylphosphine, 32.52 g of oleylamine, and 31.96 g of dioctylamine were mixed in a 200-mL reaction vessel, heated to 120° C. while stirring under a reduced pressure, and degassed for 30 minutes. After degassing, the pressure was returned to atmospheric pressure with nitrogen gas, and 37 g of the solution containing the InP quantum dots was added under a nitrogen atmosphere, and the mixture was held at a temperature raised to 230° C. for 30 minutes, and then held at a temperature further raised to 300° C. for 60 minutes, so that an oleylamine/dioctylamine dispersion of InP/ZnSe core-shell type quantum dots having InP in the core and ZnSe in the shell was obtained.

Further, after the resulting oleylamine/dioctylamine dispersion was cooled to 240° C., 16.92 g of dodecanethiol was injected and held for 90 minutes, so that an oleylamine/dioctylamine dispersion of InP/ZnSe/ZnS-multishell type quantum dots having InP in the core with ZnSe and ZnS layered in the shell was obtained.

### <Washing Step>

The obtained dispersion was cooled to room temperature, and then 600 g of acetone was added and stirred, so that the InP/ZnSe/ZnS quantum dots were recovered as a precipitate with centrifugation. The recovered InP/ZnSe/ZnS quantum dots were suspended into 34.64 g of toluene to obtain a toluene dispersion of the InP/ZnSe/ZnS quantum dots. To this dispersion, 600 g of acetone was further added and stirred, so that the InP/ZnSe/ZnS quantum dots were recovered as a precipitate with centrifugation. The recovered InP/ZnSe/ZnS quantum dots were suspended into 28 g of octane to obtain an octane dispersion of the purified InP/ZnSe/ZnS quantum dots.

### <Surface-Protecting Step>

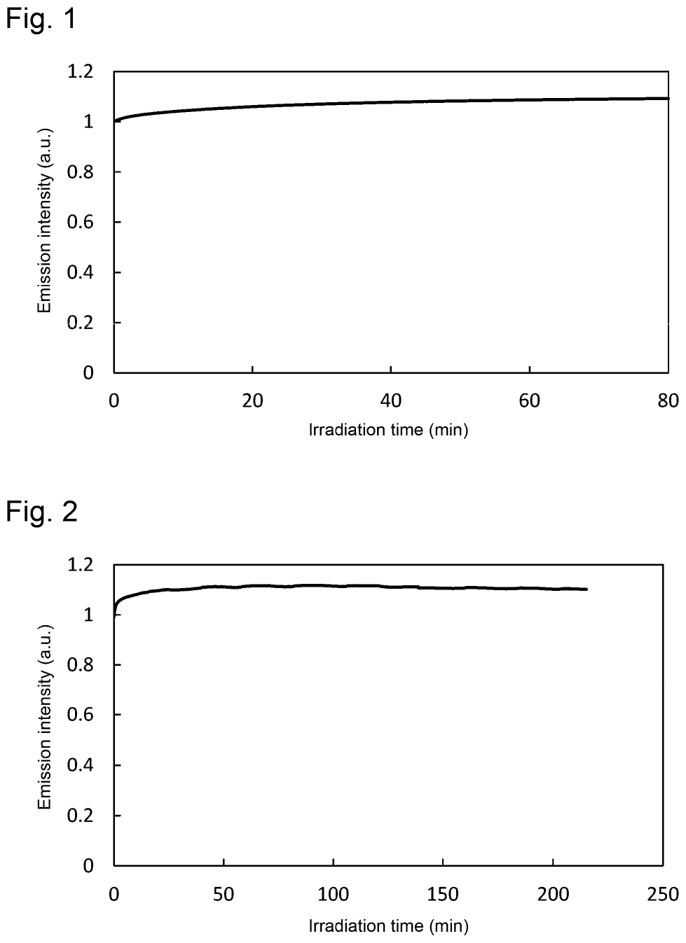

Into the obtained octane dispersion, 0.035 g of trioctylphosphine was added to obtain a trioctylphosphine-mixed octane dispersion of the purified InP/ZnSe/ZnS quantum dots. A maximum fluorescence wavelength of the obtained dispersion was 578 nm. The measurement result of the light stability test of the obtained dispersion is shown in FIG. 1. The measurement result of the light stability test over a long time of 24 hours or more is shown in FIG. 2.

### Example 2

### <Reaction Step>

An oleylamine/dioctylamine dispersion of the InP/ZnSe/ZnS-multishell type quantum dots was obtained in the same manner as in Example 1.

### <Washing Step>

The obtained dispersion was cooled to room temperature, and then 600 g of ethanol was added and stirred, so that the InP/ZnSe/ZnS quantum dots were recovered as a precipitate with centrifugation. The recovered InP/ZnSe/ZnS quantum dots were suspended into 34.64 g of toluene to obtain a toluene dispersion of the InP/ZnSe/ZnS quantum dots. To this dispersion, 600 g of ethanol was further added and stirred, so that the InP/ZnSe/ZnS quantum dots were recovered as a precipitate with centrifugation. The recovered InP/ZnSe/ZnS quantum dots were suspended into 28 g of octane to obtain an octane dispersion of the purified InP/ZnSe/ZnS quantum dots.

### <Surface-Protecting Step>

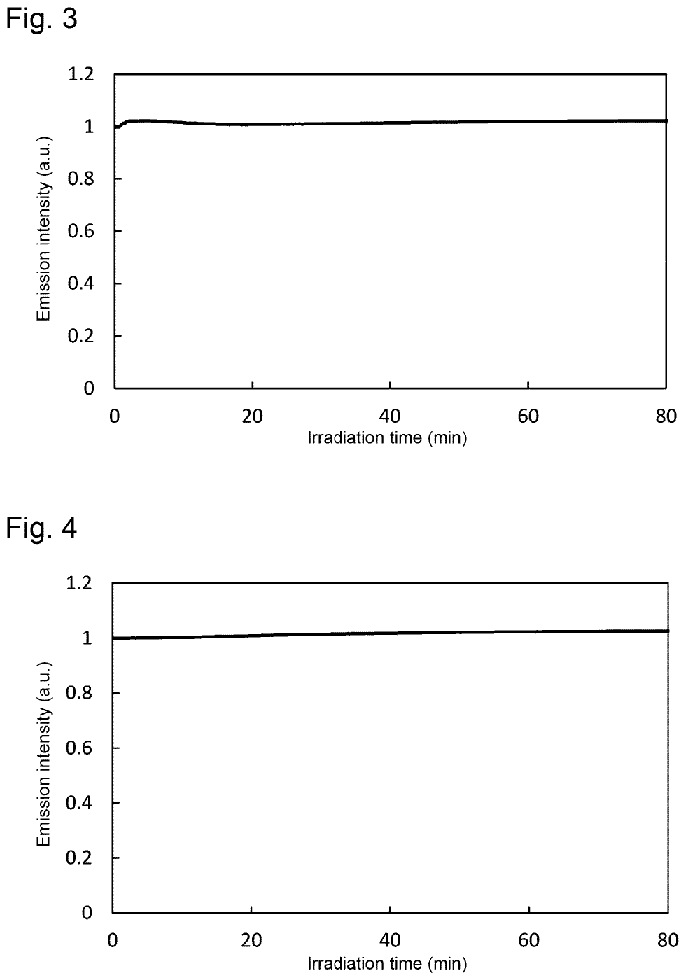

Into the obtained octane dispersion, a ligand with a type and amount shown in Table 1 was added to obtain a ligand-mixed octane dispersion of the purified InP/ZnSe/ZnS quantum dots. The measurement result of a maximum fluorescence wavelength of the obtained dispersion is shown in Table 1, and the measurement result of the light stability test is shown in FIG. 3.

### Example 3

### <Reaction Step>

An oleylamine/dioctylamine dispersion of the InP/ZnSe/ZnS-multishell type quantum dots was obtained in the same manner as in Example 1.

### <Washing Step>

The obtained dispersion was cooled to room temperature, and then 600 g of 2-propanol was added and stirred, so that the InP/ZnSe/ZnS quantum dots were recovered as a precipitate with centrifugation. The recovered InP/ZnSe/ZnS quantum dots were suspended into 34.64 g of toluene to obtain a toluene dispersion of the InP/ZnSe/ZnS quantum dots. To this dispersion, 600 g of 2-propanol was further added and stirred, so that the InP/ZnSe/ZnS quantum dots were recovered as a precipitate with centrifugation. The recovered InP/ZnSe/ZnS quantum dots were suspended into 28 g of octane to obtain an octane dispersion of the purified InP/ZnSe/ZnS quantum dots.

### <Surface-Protecting Step>

Into the obtained octane dispersion, a ligand with a type and amount shown in Table 1 was added to obtain a ligand-mixed octane dispersion of the purified InP/ZnSe/ZnS quantum dots. The measurement result of a maximum fluorescence wavelength of the obtained dispersion is shown in Table 1, and the measurement result of the light stability test is shown in FIG. 4.

### Example 4

An octane dispersion of the purified InP/ZnSe/ZnS quantum dots was obtained in the same manner as in Example 1 until the washing step.

### <Surface-Protecting Step>

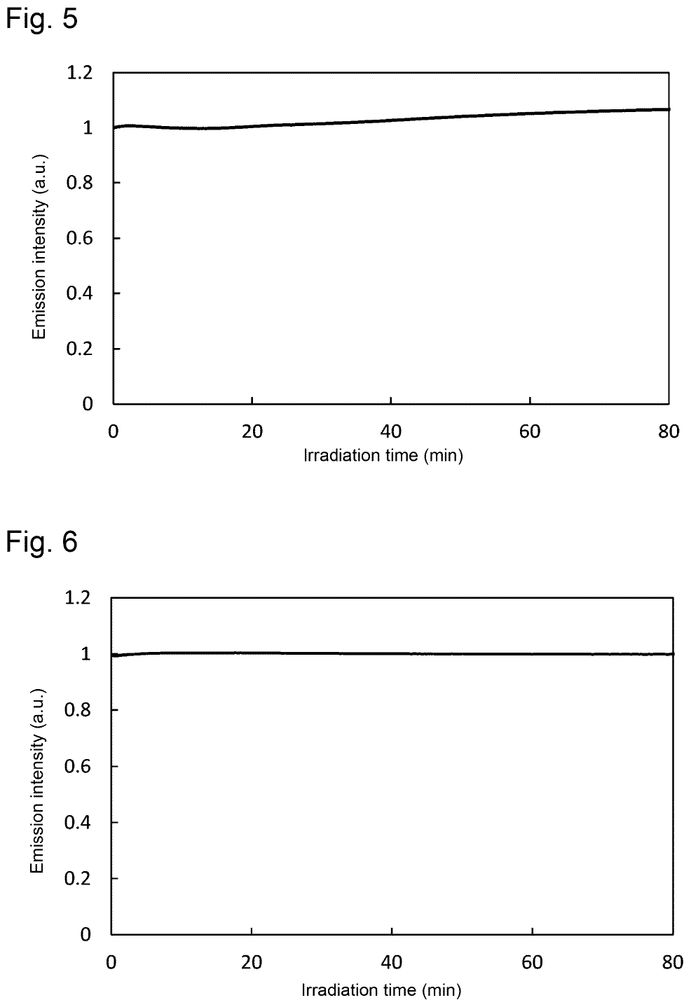

Into the obtained octane dispersion, a ligand with a type and amount shown in Table 1 was added to obtain a ligand-mixed octane dispersion of the purified InP/ZnSe/ZnS quantum dots. The measurement result of a maximum fluorescence wavelength of the obtained dispersion is shown in Table 1, and the measurement result of the light stability test is shown in FIG. 5.

### Example 5

An octane dispersion of the purified InP/ZnSe/ZnS quantum dots was obtained in the same manner as in Example 1 until the washing step.

### <Surface-Protecting Step>

Into the obtained octane dispersion, a ligand with a type and amount shown in Table 1 was added to obtain a ligand-mixed octane dispersion of the purified InP/ZnSe/ZnS quantum dots. The measurement result of a maximum fluorescence wavelength of the obtained dispersion is shown in Table 1, and the measurement result of the light stability test is shown in FIG. 6.

### Comparative Example 1

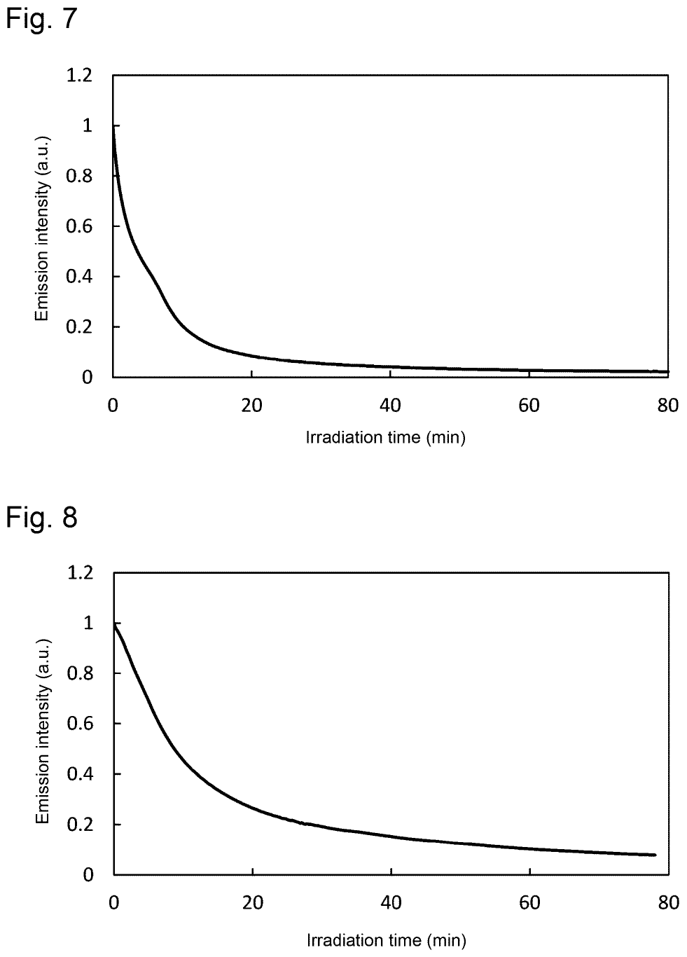

An octane dispersion of the purified InP/ZnSe/ZnS quantum dots was obtained in the same manner as in Example 1 until the washing step. A maximum fluorescence wavelength of the obtained dispersion was 578 nm. The measurement result of the light stability test of the obtained dispersion is shown in FIG. 7.

### Comparative Examples 2 to 4

Octane dispersions of the purified InP/ZnSe/ZnS quantum dots were obtained in the same manner as in Example 1 until the washing step.

### <Surface-Protecting Step>

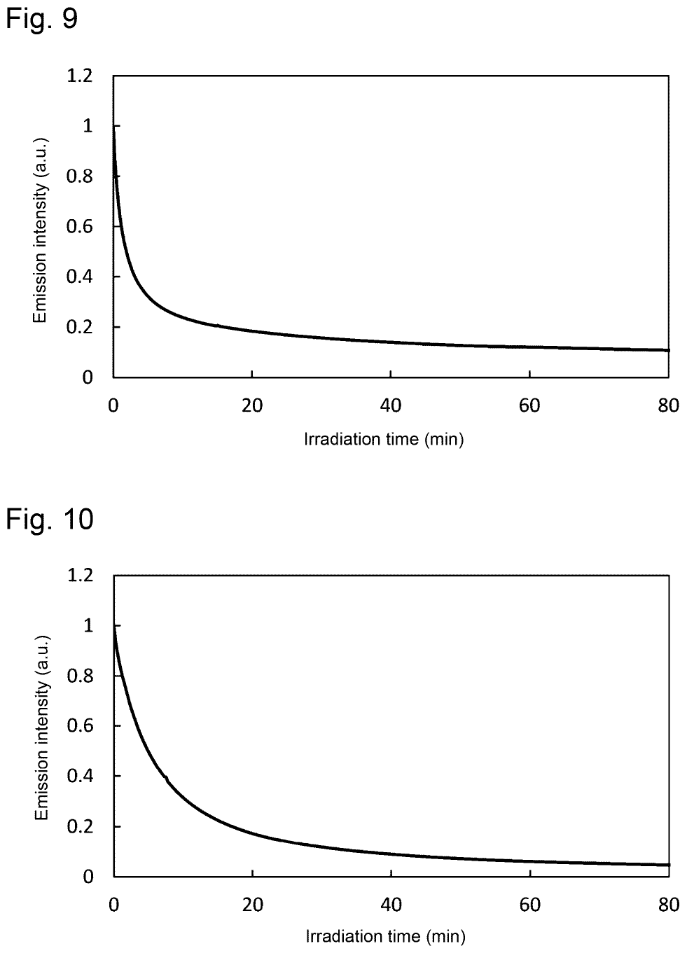

Into the obtained octane dispersion, a ligand with a type and amount shown in Table 1 was added to obtain a ligand-mixed octane dispersion of the purified InP/ZnSe/ZnS quantum dots. The measurement results of maximum fluorescence wavelengths of the obtained dispersions are shown in Table 1, and the measurement results of the light stability test are shown in FIGS. 8 to 10.

TABLE 1

| | Ligand | | Maximum |
|---|---|---|---|
| | | Addition | fluorescence |
| | Type | amount (g) | wavelength (nm) |
| Example 1 | Trioctylphosphine | 0.035 | 578 |
| Example 2 | Trimethylphosphite | 0.035 | 579 |
| Example 3 | Triethylphosphite | 0.035 | 579 |
| Example 4 | Trihexylphosphite | 0.035 | 578 |
| Example 5 | Trimethylenebis | 0.035 | 580 |
| | (dioctylphosphine) | | |
| Comparative | — | — | 580 |
| Example 1 | | | |
| Comparative | Trioctylphosphine oxide | 0.035 | 578 |
| Example 2 | | | |
| Comparative | Oleylamine | 0.035 | 579 |
| Example 3 | | | |
| Comparative | Dodecanethiol | 0.035 | 581 |
| Example 4 | | | |

From the results shown in FIGS. 1 to 10, it can be seen that, in the dispersion of the quantum dots using the ligand shown in Table 1, Examples are not found to deteriorate the emission intensity to have excellent light stability. Meanwhile, it can be seen that Comparative Examples are found to deteriorate the emission intensity.

1. A method for producing a quantum dot, comprising:
a washing step of washing a quantum dot by using an organic solvent capable of dissolving an impurity contained in a dispersion containing the quantum dot; and
a surface-protecting step of adding a ligand composed of a phosphorus compound represented by the following general formula (1) or the following general formula (2) to a dispersion of a washed quantum dot to protect a surface of the quantum dot with the ligand, 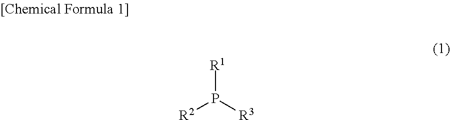
wherein R¹, R², and R³ represent a hydrogen atom, a hydroxy group, an alkyl group, a cycloalkyl group, an aryl group, a heteroaryl group, an aralkyl group, a heteroaralkyl group, an alkoxy group, or a thioalkoxy group, and R¹, R², and R³ may be the same groups or different groups, 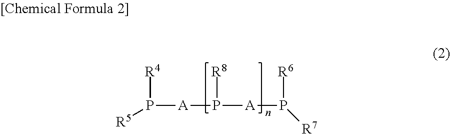
wherein R⁴, R⁵, R⁶, R⁷, and R⁸ represent a hydrogen atom, a hydroxy group, an alkyl group, a cycloalkyl group, an aryl group, a heteroaryl group, an aralkyl group, a heteroaralkyl group, an alkoxy group, or a thioalkoxy group; R⁴, R⁵, R⁶, R⁷, and R⁸ may be the same groups or different groups; when a plurality of R⁸ are present, these may be the same groups or different groups; A represents an alkylene group, a cycloalkylene group, an arylene group, an alkoxylene group, or a thioalkoxylene group; and “n” represents an integer of 0 to 3.

2. The method for producing a quantum dot according to claim 1, wherein the dispersion containing the quantum dot is a dispersion of a quantum dot having a core-shell structure, with a core composed of an InP-based quantum dot obtained by a reaction of at least a phosphorus source and an indium source, and a shell composed of a coating compound other than an InP-based one.

3. The method for producing a quantum dot according to claim 1, wherein the organic solvent in the washing step is at least one selected from the group consisting of methanol, ethanol, acetone, 2-propanol, and acetonitrile.

4. The method for producing a quantum dot according to claim 1, wherein the washing in the washing step is adding the organic solvent to the dispersion, followed by stirring, and then solid-liquid separation with centrifugation to obtain the washed quantum dot.

5. The method for producing a quantum dot according to claim 1, wherein the dispersion containing the washed quantum dot in the surface-protecting step is a dispersion in which the washed quantum dot is dispersed in a solvent composed of an aliphatic hydrocarbon.

6. The method for producing a quantum dot according to claim 1, wherein the ligand composed of the phosphorus compound in the surface-protecting step is at least one selected from the group consisting of trialkylphosphine, trialkylphosphite, a (dialkylphosphine), and bis(dialkylphosphite).
